(19) United States
(12) Patent Application Publication
(10) Pub. No.: US 2019/0393739 A1
(43) Pub. Date: Dec. 26, 2019

(54) STATOR FOR EXTERNAL ROTOR TYPE MOTOR

(71) Applicant: KOREA ELECTRONICS TECHNOLOGY INSTITUTE, Seongnam-si (KR)

(72) Inventors: Jung Moo SEO, Goyang-si (KR); Se Hyun RHYU, Bucheon-si (KR); Jeong Jong LEE, Incheon (KR); Ki Deok LEE, Bucheon-si (KR); Rae Eun KIM, Seoul (KR)

(21) Appl. No.: 16/395,518

(22) Filed: Apr. 26, 2019

(30) Foreign Application Priority Data
Jun. 21, 2018 (KR) 10-2018-0071174

(51) Int. Cl. H02K 1/14

(52) U.S. Cl. CPC H02K 1/148; H02K 2213/12

(57) ABSTRACT

The present invention is to provide a stator for external rotor type motor, enabling to manufacture a motor with a high viscosity rate by allowing a unit tooth of a stator to be partially separated from an adjacent tooth.

In order to accomplish the object of the present invention, there is provided a stator for external rotor type motor, comprising: a unit yoke; and a plurality of unit modules including a unit tooth extensively formed on the unit yoke, wherein the plurality of unit modules is continuously formed in a ring shape, and the unit yoke includes a connection part connected to an adjacent unit yoke, and a dividing part separated from the adjacent unit yoke, and one unit module in the plurality of unit modules is mutually separated from the adjacent unit module by a cutting part.

### CROSS REFERENCE TO RELATED APPLICATIONS

Pursuant to 35 U.S.C.§ 119 (a), this application claims the benefit of earlier filing dates and rights of priority to Korean Patent Application No.: 10-2018-0071174 filed on Jun. 21, 2018, the contents of which are hereby incorporated by reference in their entirety.

### TECHNICAL FIELD

The present invention relates to a stator for external rotor type motor, and more particularly, to a stator for external rotor type motor configured to increase a coil viscosity rate.

### BACKGROUND ART

The external rotor type motor, particularly brushless type external rotor type motor, has been largely used as a power source for unmanned aircrafts such as drones due to high output density, and is a motor having a high possibility of being expanded in use area in the future.

Meantime, the external rotor type motor is manufactured by winding a coil inside a slot of stator iron core using an automatic winding machine. Particularly, although this method has an advantage in that a separate jig is manufactured in response to the shape of rotor iron core, and desired coils and turns of coil wire are selected to enable a high speed operation, there is a limit in coil viscosity rate because a space for allowing a needle or a flyer of the automatic winding machine to move inside the slot must be obtained. Hence, for example, in case of motors calling for a high output power density (output ratio versus weight) such as robot joint driving motors and drone driving motors, the winding operations are performed by hands, which is disadvantageous in terms of manufacturability and manufacturing cost.

Meantime, in order to increase the coil viscosity, various types of structures are proposed and one of the representative methods is a divided stator.

For example, the Korean Laid-Open Patent No.: 2005-0107644 discloses an outer rotor type motor having a divided stator, comprising: a stator including a plurality of hollowed cylindrical center cores formed with a central hole penetratively formed on a body center, and formed at an outer circumferential surface with a coupling part to a circumferential direction each at a predetermined space, and a plurality of divided cores having a coupled part fixed to the coupling part and continuously arranged on an outer circumferential surface of the center core to a circumferential direction by being wound with a coil; and a rotor arranged at an outside of the stator and formed with a ring-shaped permanent magnet having an N pole and an S pole alternately magnetized to a circumferential direction.

Furthermore, the Korean Laid-Open Patent No.: 1996-0039531, which relates to a stator of a linear compressor motor that has solved the difficulty of winding operation by changing the structure of stacked iron cores, discloses a stator of a motor including a cylindrical stacked iron cores and a plurality of iron core teeth radially coupled at an upper and a lower side of an inside of the stacked iron cores for attachment and detachment, where the plurality of iron core teeth is wound with a coil to an opposite direction from that of adjacent iron core teeth, whereby winding can be easily implemented because the iron core teeth is separately performed from the stacked iron cores when the coil is wound.

Although the abovementioned patents are intended to perform an easy winding using a divided stator structure, these patents suffer from disadvantages in that most of the teeth portions are separated to thereby consume lots of man hours due to lots of teeth being coupled during actual assembly, and the winding structure is complicated, such that situations are that there is a need of a new type of stator convenient in manufacturing and capable of increasing a viscosity rate.

### DISCLOSURE OF THE INVENTION

### Technical Subject

The present invention is provided to overcome the disadvantages of the prior art, and it is an object of the present invention to provide a stator for external rotor type motor, enabling to manufacture a motor with a high viscosity rate by allowing a unit tooth of a stator to be partially separated from an adjacent tooth.

### Technical Solution

In one general aspect of the present invention, there is provided a stator for external rotor type motor comprising:

a unit yoke; and

a plurality of unit modules including a unit tooth extensively formed on the unit yoke, wherein the plurality of unit modules may be continuously formed in a ring shape, and

the unit yoke may include a connection part connected to an adjacent unit yoke, and a dividing part separated from the adjacent unit yoke, and

one unit module in the plurality of unit modules may be mutually separated from the adjacent unit module by a cutting part.

Preferably, but not necessarily, the dividing part of the unit yoke may include a coupling means for being coupled to the adjacent unit yoke.

Preferably, but not necessarily, the coupling means may be a lug coupled to a groove formed on the dividing part of the unit yoke at one side and to a groove formed on a unit yoke of the other side.

Preferably, but not necessarily, the dividing part may further include a circular part.

Preferably, but not necessarily, the stator for external rotor type motor may comprise two unit stators in which another unit module is mutually separated from adjacent unit module by a cutting part to allow a plurality of unit modules to be coupled.

Preferably, but not necessarily, the stator for external rotor type motor may comprise three unit stators in which still further two unit modules are mutually separated from adjacent unit modules by a cutting part to allow a plurality of unit modules to be coupled.

Preferably, but not necessarily, the stator for external rotor type motor may comprise four unit stators in which still further three unit modules are mutually separated from adjacent unit modules by a cutting part to allow a plurality of unit modules to be coupled.

Preferably, but not necessarily, the cutting part may be formed to a connection part direction from the circular part.

### Advantageous Effects

The stator for external rotor type motor according to the present invention has an advantageous effect in that a unit yoke and a unit module including a unit tooth extensively formed on the unit yoke are roundly arranged, and particularly, the unit yoke includes a lower part connected to adjacent unit yoke and a dividing part separated from the lower part to allow unit modules to be mutually separably arranged, whereby the number of turns can be increased during the winding operation and a high coil viscosity rate can be accomplished and a manufacturing time can be reduced because the unit modules can be mutually coupled during completion of winding operation.

### BRIEF DESCRIPTION OF DRAWINGS

FIG. 1 is a front view illustrating an external shape of stator for external rotor type motor according to the present invention,

FIG. 2 is a front view when unit modules of FIG. 1 are mutually coupled,

FIG. 3 is an explanatory view illustrating a closed type stator structure,

FIG. 4 is an explanatory view illustrating a fixed structure including one cutting part,

FIG. 5 is an explanatory view illustrating a fixed structure including two cutting parts,

FIG. 6 is an explanatory view illustrating a fixed structure including three cutting parts, and

FIG. 7 is an explanatory view illustrating a cutting part applied to the FIG. 1.

### DETAILED DESCRIPTION OF THE PRESENT INVENTION

Hereinafter, exemplary embodiments of the present invention will be described in detail with reference to the accompanying drawings.

Furthermore, the suffixes ‘module’, ‘unit’ and ‘part’ may be hereinafter used for elements in order to facilitate the invention. Significant meanings or roles may not be given to the suffixes themselves and it is understood that the ‘module’, ‘unit’ and ‘part’ may be used together or interchangeably.

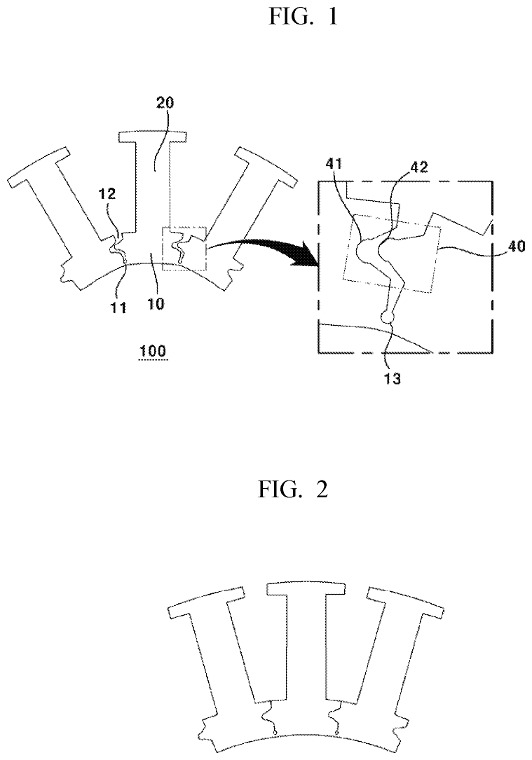

As illustrated in FIG. 1, the stator (100) for external rotor type motor according to the present invention may be configured to comprise continuously arranged unit modules (30) including a unit yoke (10) and a unit tooth (20) extensively formed on the unit yoke (10).

The unit yoke (10) may be configured in an arch type and, when continuously arranged, an entire configuration of the unit yoke may take a ring shape.

Furthermore, the unit module (30) may be foil led by stacking a plurality of iron cores as shown in FIG. 1, where a stacked height may be pre-set in response to a motor requirement condition.

Meantime, a mutually-connected connection part (11) and a mutually separated dividing part (12) are formed between the unit yoke (10) and adjacent unit yoke (10).

In addition, the dividing part (12) may include a coupling means (40) in order to accurately couple the adjacent unit yoke (10).

The coupling means (40) may be configured in such a manner that one side of the unit yoke (10) may be formed in a groove (41) shape, and the other side coupled to the one side of the unit yoke (10) may be formed with a lug (42) having a shape corresponding to that of the groove (41) whereby fixability of both unit yokes (10) can be increased when the unit yokes (10) are coupled.

The groove (41) and the lug (42) may be formed in any shape that can be separated and coupled.

Meantime, if necessary, a starting area of the dividing part (12) may be foil led with a round part (13) in order to increase rotatability with adjacent unit yokes (10).

Furthermore, the round part (13) has an advantageous effect of preventing a crack that may be generated toward the connection part (11) from the dividing part (12) in response to deformation of the unit yoke (10).

Meantime, the stator (100) may be such that the winding is progressed while the dividing part (12) is in a widened state, as illustrated in FIG. 1. Thereafter, when the winding is completed, the dividing part (12) may be closed as illustrated in FIG. 2, where the groove (41) formed at each dividing part (12) and adjacent unit modules (30) may be tightly coupled by the lug (42).

The stator (100) may be configured by allowing the unit modules (30) to be continuously arranged to form a ring shape. At this time, when the unit modules (30) are continuously arranged, the unit yoke (10) may be completely contacted to adjacent unit yoke (10) to form a ring-shaped yoke (50).

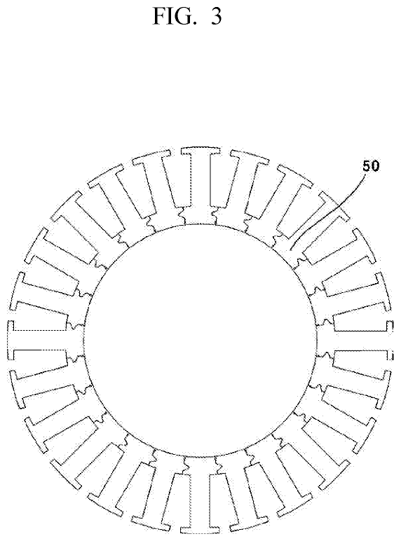

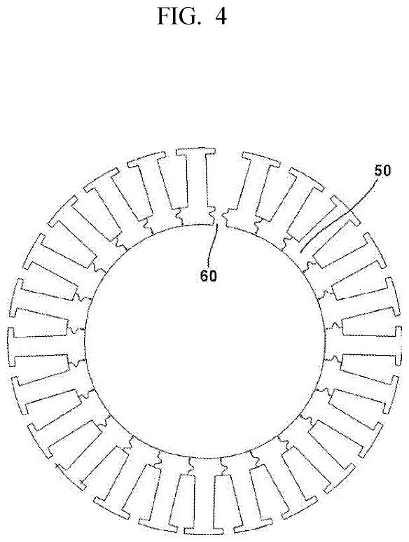

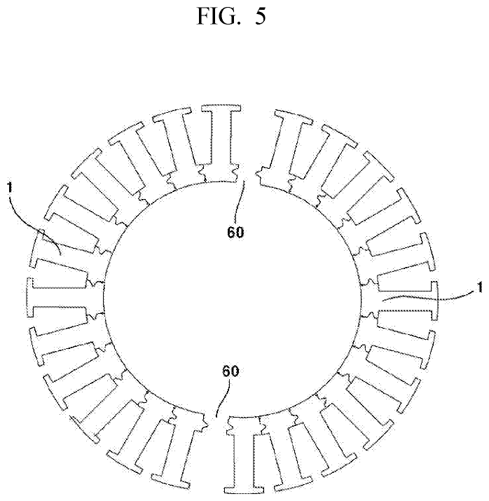

At this time, when the yoke (50) is faulted in a closed type, as shown in FIG. 3, the dividing part (12) may not be widened by the geometrical structure to be same as the conventional stator structure formed with yoke and a plurality of teeth, such that one cutting part (60) can be formed, as shown in FIG. 4, to allow accommodating the deformation of yoke (50).

If necessary, as illustrated in FIG. 5, two cutting parts (60) may be formed to allow the stator (100) to be formed with two unit stators (1).

It would be more advantageous, in terms of operational aspect, to form the stator (100) by dividing into two unit stators (1) than for one cutting part (60).

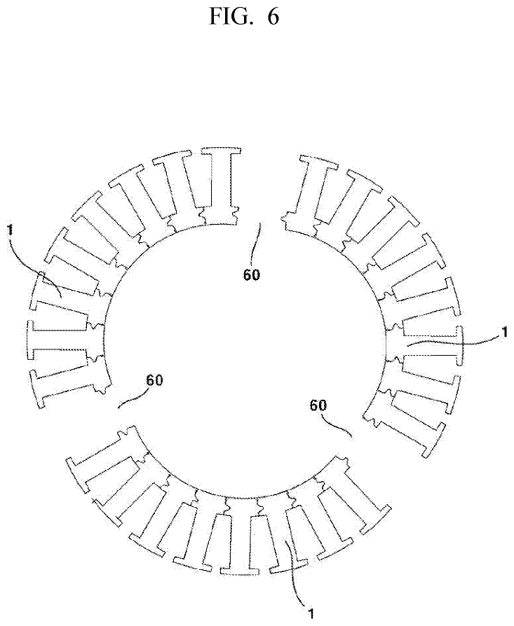

Furthermore, if necessary, as illustrated in FIG. 6, three cutting parts (60) may be configured to divisibly form three unit stators (1), and in the same context, four or more unit stators (1) may be configured with the same method.

At this time, it would be advantageous to form the unit stator (1) with the same length for parts sharing and winding arrangement.

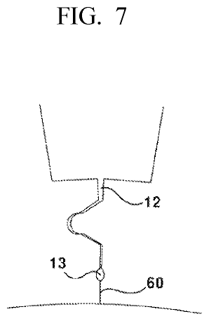

Furthermore, it would be advantageous to form by cutting from a starting area of a dividing part (12) of a particular unit yoke (10) to a connection part (11) direction over cutting other areas because the cut length is short as illustrated in FIG. 7.

Meantime, when the winding is completed, the cutting part (60) may be joined by welding to allow forming a closed ring-shaped yoke (50).

Meantime, in view of the fact that the stators (100) are formed by the same number of unit stators (1) in response to the number of cutting parts (60), and when the number of cutting parts (60) are increased, the number of welding parts are increased to be disadvantageous to the manufacturing standpoint of view, such that it would be preferable to determine in consideration of size of motor and the number of unit modules (30), but configuration of five (5) or more cutting parts (60) is generally inadequate due to increased number of welding processes.

Meantime, the assembly of stator (100) according to the present invention may be processed in the following fashion:

First, as illustrated in FIG. 1, the winding is sequentially performed on each unit tooth (20) while the dividing part (12) is divided from the unit yokes (10) and the adjacent unit yokes (10). Because the dividing part (12) is in a divided state, an area between the unit tooth (20) and the unit tooth (20) may be maximized to allow the coil to be advantageously wound to the maximum.

Thereafter, when all unit teeth (20) are completed in winding, each dividing part (12) is coupled, the front part (60) is welded to finally complete the operation.

At this time, when the cutting part (60) is numbered at one, the winding is to be started from a unit tooth (20) formed with all the cutting parts (60) to complete by rotating 360°.

When the cutting part (60) is numbered at two or more, the winding is to be started from one unit stator (1) because the unit stator (1) is numbered at more than two, and the winding is processed in the arranged order of unit stator (1).

It should be apparent that when the winding is completed, the dividing parts (12) are coupled, and the cutting parts (60) are welded to complete the manufacturing of entire stator (100).

Meantime, when the stator (100) is formed with a plurality of unit stators (1), and the coil is independently wound on each unit stator (1), the winding may be simultaneously implemented on the plurality of unit stators (1), the dividing parts (12) are coupled and finally the plurality of cutting parts (60) are welded to complete the manufacturing.

The stator for external rotor type motor according to the present invention is not limitedly applied to the abovementioned exemplary embodiments, and the exemplary embodiments may be selectively combined in whole or in part to allow realizing various variations.

Although the abovementioned embodiments according to the present invention have been described in detail with reference to the above specific examples, the embodiments are, however, intended to be illustrative only, and thereby do not limit the scope of protection of the present invention. Therefore, it should be appreciated by the skilled in the art that changes, modifications and amendments to the above examples may be made without deviating from the scope of protection of the invention, and these changes, modifications and amendments may not be individually interpreted from the technical ideas or prospects of the present invention.

[Description of Reference Numerals]

| | | |
|---|---|---|
| 1: | unit stator | 10: unit yoke |
| 11: | connection part | 12: dividing part |
| 13: | round part | 20: unit tooth |
| 30: | unit module | 40: coupling means |
| 41: | groove | 42: lug |
| 50: | yoke | 60: cutting part |
| 100: | stator | |

1. A stator for external rotor type motor, comprising:
a unit yoke; and
a plurality of unit modules including a unit tooth extensively formed on the unit yoke, wherein the plurality of unit modules is continuously formed in a ring shape,
the unit yoke includes a connection part connected to an adjacent unit yoke, and a dividing part separated from the adjacent unit yoke, and
one unit module in the plurality of unit modules is mutually separated from the adjacent unit module by a cutting part.

2. The stator of claim 1, wherein the dividing part of the unit yoke includes a coupling means for being coupled to the adjacent unit yoke.

3. The stator of claim 2, wherein the coupling means includes a groove formed on the dividing part of the unit yoke at one side and a lug formed on the dividing part of the unit yoke at other side to be coupled to the groove.

4. The stator of claim 3, wherein the dividing part further includes a circular part.

5. The stator of claim 1, further comprising: two unit stators, in which another unit module is mutually separated from adjacent unit module by a cutting part to allow a plurality of unit modules to be coupled.

6. The stator of claim 1, further comprising: three unit stators, in which still further two unit modules are mutually separated from adjacent unit modules by a cutting part to allow a plurality of unit modules to be coupled.

7. The stator of claim 1, further comprising: four unit stators in which still further three unit modules are mutually separated from adjacent unit modules by a cutting part to allow a plurality of unit modules to be coupled.

8. The stator of claim 4, wherein the cutting part is formed to a connection part direction from the circular part.

9. The stator of claim 1, wherein the one unit module and the adjacent unit module are coupled by welding.

10. The stator of claim 3, wherein the unit yoke is formed at one side with a groove and formed at the other side with a lug.

11. The stator of claim 4, wherein the round part is arranged at an inside of the coupling means.
